(19) United States
(12) Patent Application Publication
(10) Pub. No.: US 2013/0055131 A1
(43) Pub. Date: Feb. 28, 2013

(54) Animation for Cut and Paste of Content

(71) Applicants: Josh Leong, Seattle, WA (US); Christopher D. Edwards, Seattle, WA (US)

(72) Inventors: Josh Leong, Seattle, WA (US); Christopher D. Edwards, Seattle, WA (US)

(73) Assignee: Microsoft Corporation, Redmond, WA (US)

(21) Appl. No.: 13/219,074

(22) Filed: Aug. 26, 2011

(51) Int. Cl. G06F 3/048

(52) U.S. Cl. 715/770

(57) ABSTRACT

Animation for the cut and paste of content in an electronic document may be provided. A user interface may be displayed on a computer which includes a content surface for editing the content. The computer may then cut the content from a first location in response to a received request. The computer may then paste the content to a second location on the content surface in response to a received request. The pasting of the content from the first location to the second location may be displayed as a gradual transition of the content on the content surface.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

A number of computer application programs include functionality for the cutting and pasting of content from within a single electronic document or between multiple electronic documents. For example, a spreadsheet application program may include functionality for cutting displayed content (e.g., text and numbers) from a group of cells located at the top of a spreadsheet and for pasting the displayed content to a location at the bottom of the spreadsheet. Similarly, a word processing application program may include functionality for pasting content previously cut from another document (e.g., an image) into a word processing document generated by the word processing application. Current cut-and-paste functionality however, does not provide a real-world user experience for most users. For example, utilizing current functionality, content which is cut from an electronic document simply disappears and then later reappears as pasted content. Thus, current cut-and-paste functionality lacks a real-word physical analogy which may be familiar with most users when an object is moved from one location to another. In particular, in the real world, users are used to perceiving the movement of an object as it travels between locations. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for animating the cut and paste of content in an electronic document. A user interface may be displayed on a computer which includes a content surface for editing the content. The computer may then cut the content from a first location in response to a received request. The computer may then paste the content to a second location on the content surface in response to a received request. The pasting of the content from the first location to the second location may be displayed as a gradual transition of the content on the content surface.

These and other features and advantages will be apparent from a reading of the following detailed description and a review of the associated drawings. It is to be understood that both the foregoing general description and the following detailed description are illustrative only and are not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 is a computer screen display of a user interface showing content which has been cut from a first location and is in the process of being pasted to a second location in an electronic document, in accordance with an embodiment;

FIG. 2 is a computer screen display of a user interface showing pasted content in an electronic document following a paste operation, in accordance with an embodiment;

FIG. 3 is a computer screen display of a user interface showing content which is in the process of being pasted to a location previously occupied by pre-existing content in an electronic document, in accordance with an embodiment;

FIG. 4 is a computer screen display of a user interface showing pasted content in an electronic document following a paste operation, in accordance with an embodiment;

FIG. 5 is a computer screen display of a user interface showing content which is in the process of being pasted to a location previously occupied by pre-existing content in an electronic document, in accordance with an embodiment;

FIG. 6 is a computer screen display of a user interface showing pasted content in an electronic document following a paste operation, in accordance with an embodiment;

FIG. 7 is a flow diagram illustrating a routine for animating the cut and paste of content in an electronic document, in accordance with an embodiment;

FIG. 8 is a flow diagram illustrating a routine for animating the pasting of content in an electronic document, in accordance with an embodiment;

FIG. 9 is a flow diagram illustrating a routine for animating the pasting of content in an electronic document, in accordance with an embodiment;

FIG. 10 is a simplified block diagram of a computing device with which various embodiments may be practiced;

FIG. 11A is a simplified block diagram of a mobile computing device with which various embodiments may be practiced;

FIG. 11B is a simplified block diagram of a mobile computing device with which various embodiments may be practiced; and

FIG. 12 is a simplified block diagram of a distributed computing system in which various embodiments may be practiced.

### DETAILED DESCRIPTION

Embodiments are provided for animating the cut and paste of content in an electronic document. A user interface may be displayed on a computer which includes a content surface for editing the content. The computer may then cut the content from a first location in response to a received request. The computer may then paste the content to a second location on the content surface in response to a received request. The pasting of the content from the first location to the second location may be displayed as a gradual transition of the content on the content surface.

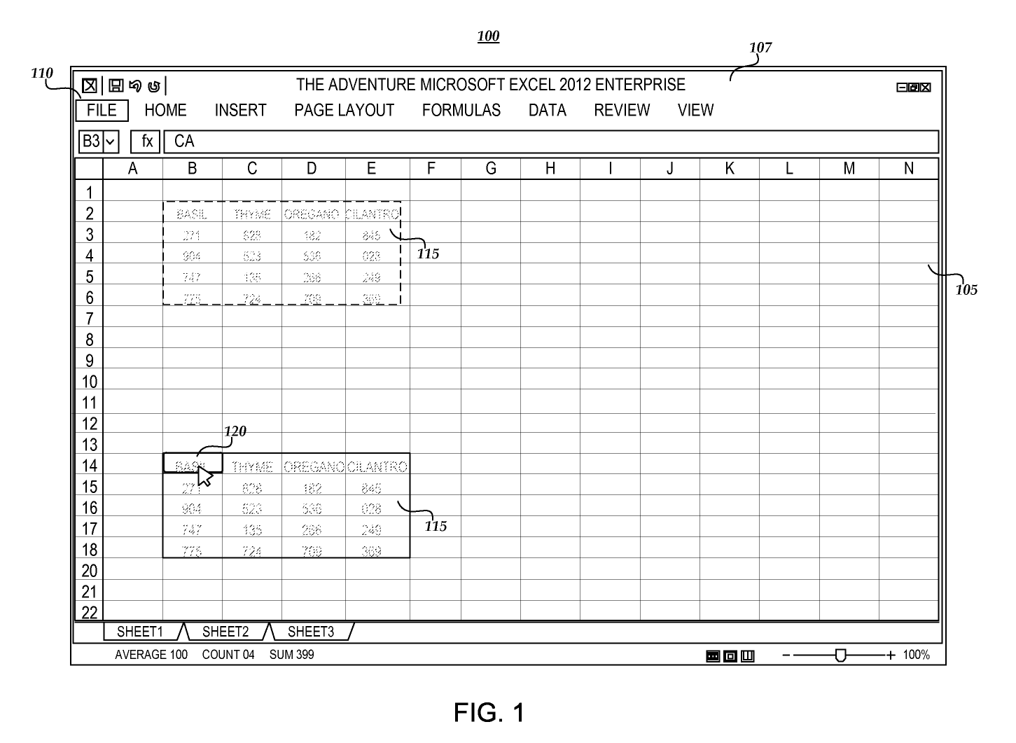

FIG. 1 is a computer screen display of a user interface 100 showing content 115 which has been cut from a first location and is in the process of being pasted to a second location in an electronic document 107, in accordance with an embodiment. The user interface 100 may include a content surface 105 for displaying the content 115 in the electronic document 107. The user interface 100 may be generated by one or more productivity applications executing on a computing device. The productivity applications may include, but are not limited to, word processing software, presentation graphics software, spreadsheet software, diagramming software, project management software, publishing software, personal information management software and note-taking software. The user interface 100 may further include a toolbar 110 which may provide menus and/or icons comprising commands for the cutting, copying and pasting of the content 115. For example, in accordance with various embodiments, a Cut command may be initiated by a keyboard shortcut command (e.g., CTRL+C), a selection of the Cut command from a menu in the toolbar 110 and/or a selection of a Cut icon (e.g., a scissors icon—not shown) from the toolbar 110. In response to receiving a Cut command in the user interface 100, the content 115 may be shown surrounded by animated dashed lines indicating that the content 115 has been cut from the electronic document 107 (i.e., a spreadsheet). It should be understood that the content cut from other types of electronic documents (e.g., a word processing document) may simply be removed from the document. In accordance with various embodiments, a Paste command may be initiated by a keyboard shortcut command (e.g., CTRL+V), a selection of the Paste command from a menu on the toolbar 110 and/or a selection of a Paste icon (e.g., a clipboard icon—not shown) from the toolbar 110. As will be described in greater detail herein and in accordance with an embodiment, in response to receiving a Paste command in the user interface 100, the content 115 may gradually transition from the original or cut location to a previously selected paste location 120 on the content surface 105. The gradual transition may comprise the display of the content 115 surrounded by the dashed lines (i.e., the “cut” content) gradually shrinking or “scaling out” and fading out from view while, at the paste location 120, the content 115 is displayed as gradually “scaling in” and fading into view. It should be understood that the fading out and scaling out and the scaling in and fading operations may be synchronous such that as the cut content 115 is gradually disappearing from view on the content surface 105, the pasted content 115 is gradually coming into view at the paste location 120. It should further be understood that the “scaling out” or shrinking of the content 115 may comprise displaying the content 115 in the user interface 100 as gradually reducing in size (e.g., to a smaller and narrower font) as compared to the size of the content 115 prior to the paste operation being initiated. It should further be understood that the expanding or “scaling in” of the content 115 may comprise displaying the content 115 in the user interface 100 as gradually increasing in size (e.g., increasing the size of text from a smaller and narrower font to a larger and wider font) until the size of the content 115 has returned to its original size. For example, FIG. 1 shows a snapshot of the gradual transitions discussed above. In particular, the cut content 115 (i.e., the content surrounded by the dashed lines) is shown as faded out and smaller in size than the size of the pasted content 115 displayed at the paste location 120 which is being faded in.

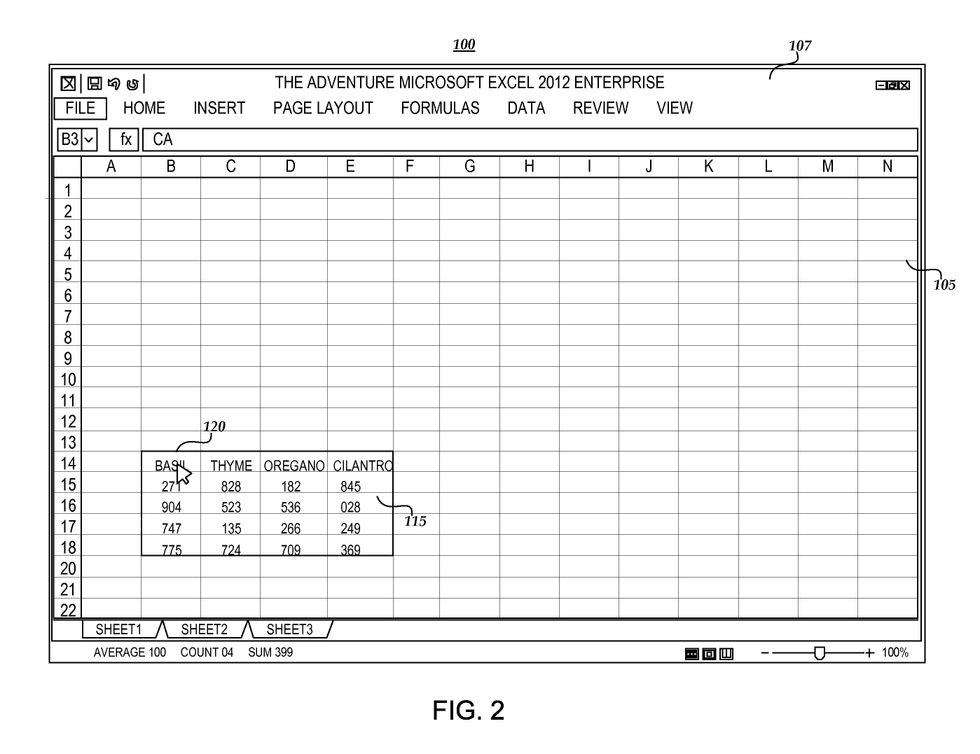

FIG. 2 is a computer screen display of a user interface 100 showing the pasted content 115 in the electronic document 107 following the completion of the paste operation discussed above with respect to FIG. 1, in accordance with an embodiment. The user interface 100 may fully display the pasted content 115 at the paste location 120 in the electronic document 107 while the content 115 previously cut from the content surface 105 is no longer visible.

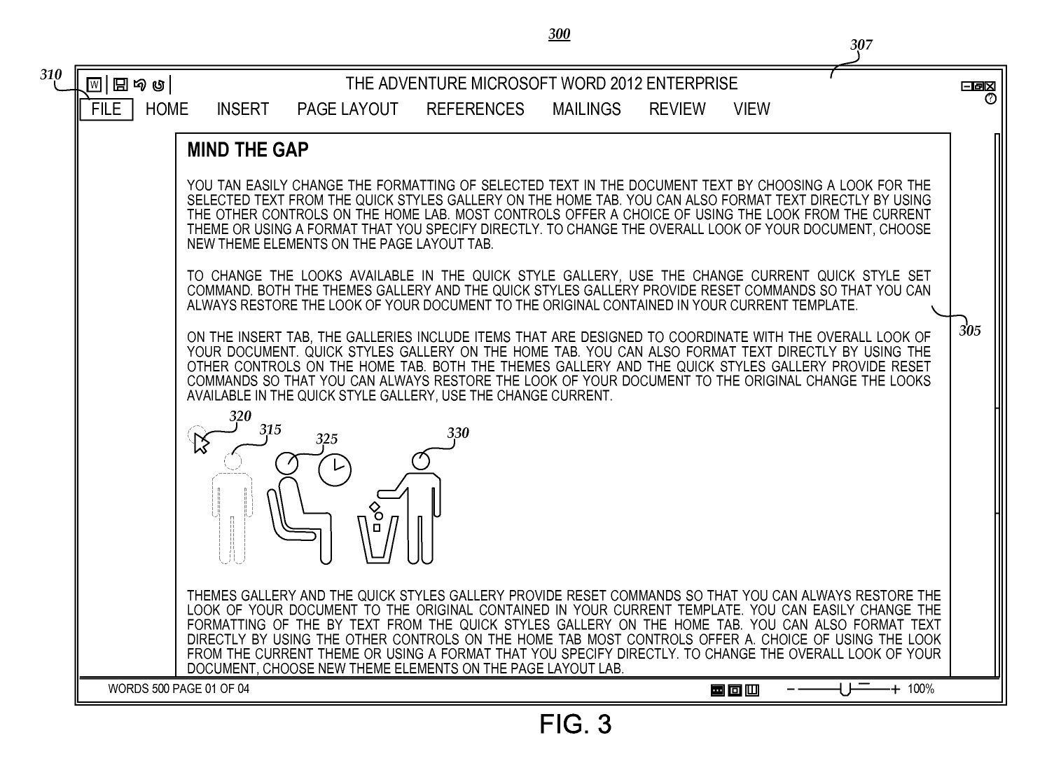

FIG. 3 is a computer screen display of a user interface 300 showing content 315 which is in the process of being pasted to a location previously occupied by pre-existing content 325, 330 in an electronic document 307, in accordance with an embodiment. The user interface 300 may include a content surface 305 for displaying the content 315 in the electronic document 307. The user interface 300 may be generated by one or more productivity applications executing on a computing device. The productivity applications may include, but are not limited to, word processing software, presentation graphics software, spreadsheet software, diagramming software, project management software, publishing software, personal information management software and note-taking software. The user interface 300 may further include a toolbar 310 which may provide menus and/or icons comprising commands for the cutting, copying and pasting of the content 315. For example, in accordance with various embodiments, a Paste command may be initiated by a keyboard shortcut command (e.g., CTRL+V), a selection of the Paste command from a menu on the toolbar 310 and/or a selection of a Paste icon (e.g., a clipboard icon—not shown) from the toolbar 310. As will be described in greater detail herein and in accordance with an embodiment, in response to receiving a Paste command in the user interface 300, the content 315 may gradually transition into view at paste location 320 on the content surface 305. The gradual transition may comprise displaying the content 315 as gradually “scaling in” and fading into view on the content surface 305. It should be understood that the content 315 may have been previously cut (or copied) from a location outside of the content surface 305 in the electronic document 307. For example, the content 315 may have been previously cut or copied from another page of the electronic document 307 or a different electronic document. It should be understood, in accordance with an embodiment, that as the content 315 is being pasted to the paste location 320, the pre-existing content 325, 330 at the paste location 320 is dynamically moved away from the paste location 320. For example, as shown in FIG. 3, the pre-existing content 325, 330 is in the process of being horizontally shifted to the right as the content 315 is being pasted to the paste location 320.

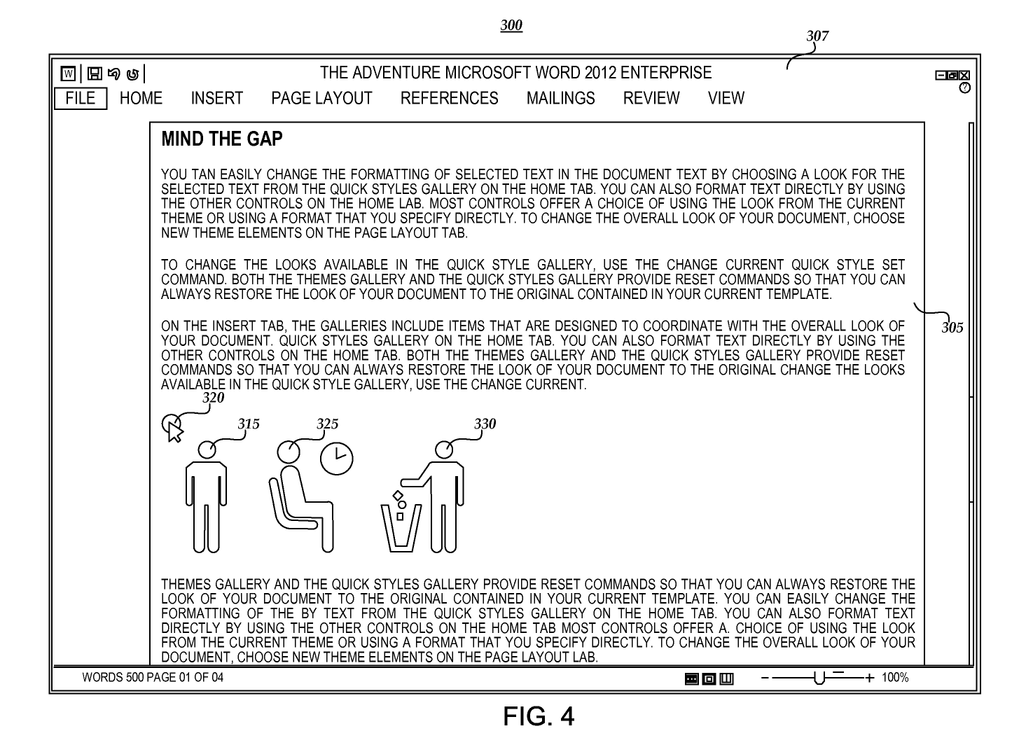

FIG. 4 is a computer screen display of the user interface 300 showing the pasted content 315 in the electronic document 307 following the completion of the paste operation discussed above with respect to FIG. 3, in accordance with an embodiment. The user interface 300 may fully display the pasted content 315 at the paste location 320 in the electronic document 307 as well as display the pre-existing content 325, 330 at their new locations after having been horizontally shifted to the right.

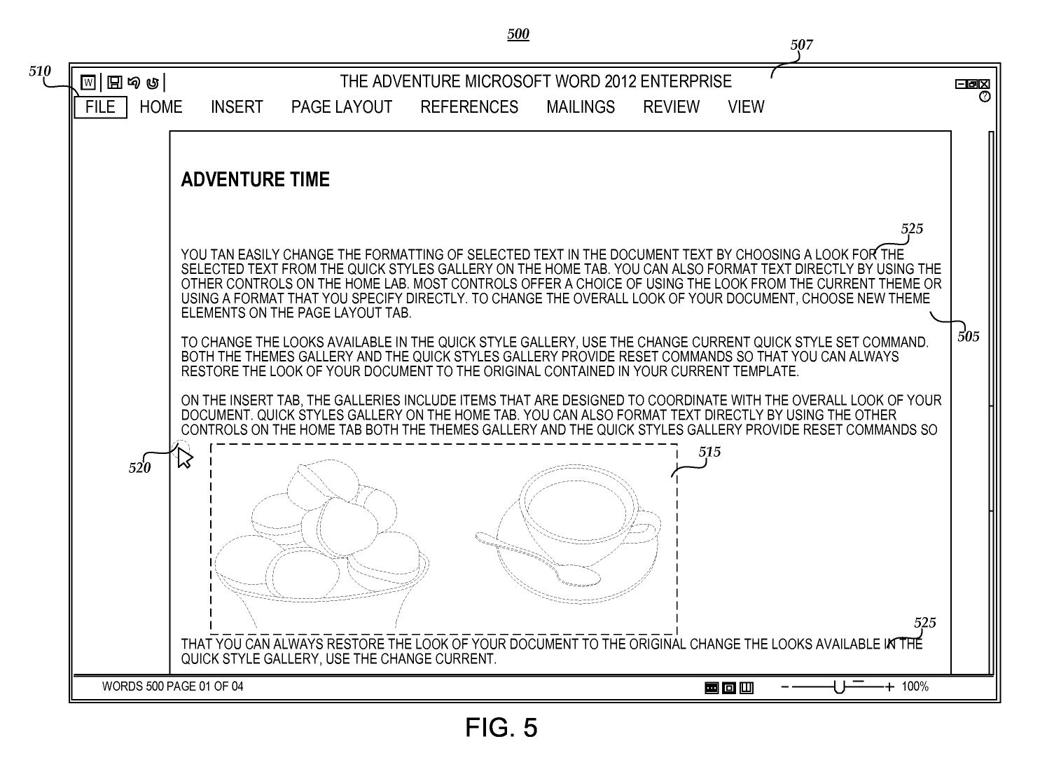

FIG. 5 is a computer screen display of a user interface 500 showing content 515 which is in the process of being pasted to a location previously occupied by pre-existing content 525 in an electronic document 507, in accordance with an embodiment. The user interface 500 may include a content surface 505 for displaying the content 515 in the electronic document 507. The user interface 500 may be generated by one or more productivity applications executing on a computing device. The productivity applications may include, but are not limited to, word processing software, presentation graphics software, spreadsheet software, diagramming software, project management software, publishing software, personal information management software and note-taking software. The user interface 500 may further include a toolbar 510 which may provide menus and/or icons comprising commands for the cutting, copying and pasting of the content 515. For example, in accordance with various embodiments, a Paste command may be initiated by a keyboard shortcut command (e.g., CTRL+V), a selection of the Paste command from a menu on the toolbar 510 and/or a selection of a Paste icon (e.g., a clipboard icon—not shown) from the toolbar 510. As will be described in greater detail herein and in accordance with an embodiment, in response to receiving a Paste command in the user interface 500, the content 515 may gradually transition into view at paste location 520 on the content surface 505. The gradual transition may comprise displaying the content 515 as gradually “scaling in” and fading into view on the content surface 505. It should be understood that the content 515 may have been previously cut (or copied) from a location outside of the content surface 505 in the electronic document 507. For example, the content 515 may have been previously cut or copied from another page of the electronic document 507 or a different electronic document. It should be understood, in accordance with an embodiment, that as the content 515 is being pasted to the paste location 520, any pre-existing content 525 at the paste location 520 is dynamically moved away from the paste location 520. For example, as shown in FIG. 5, the pre-existing content 525 is in the process of being vertically shifted in a downward direction as the content 515 is being pasted to the paste location 520.

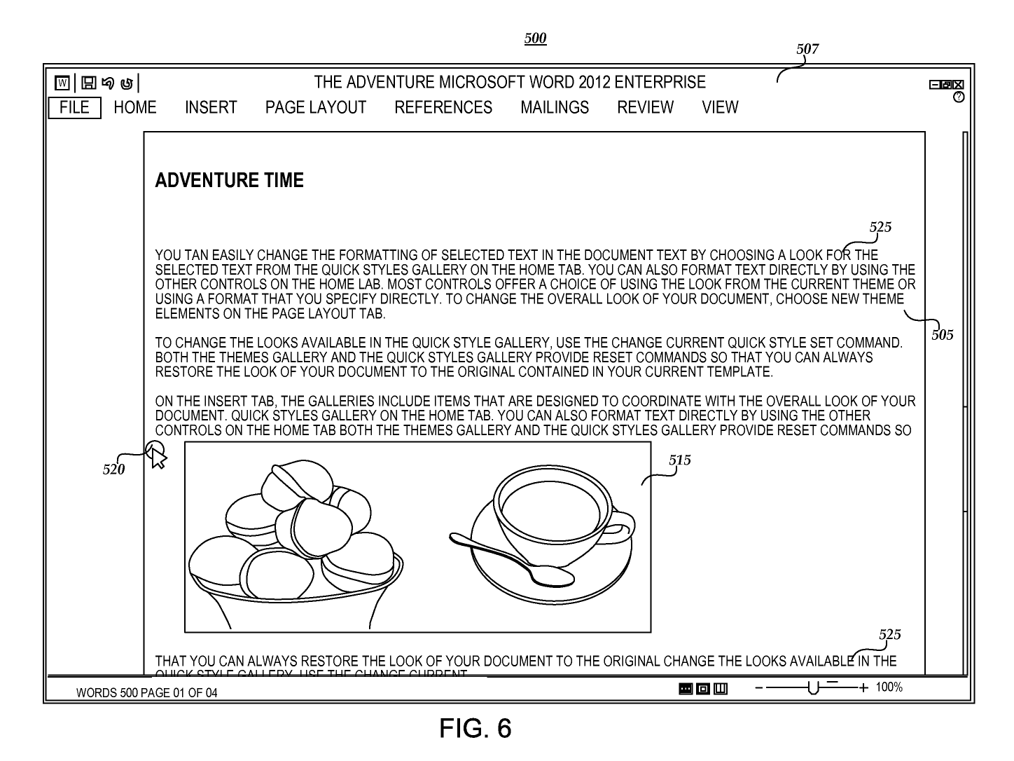

FIG. 6 is a computer screen display of the user interface 500 showing the pasted content 515 in the electronic document 507 following the completion of the paste operation discussed above with respect to FIG. 5, in accordance with an embodiment. The user interface 500 may fully display the pasted content 515 at the paste location 520 in the electronic document 507 as well as display the pre-existing content 525 at its new location after having been vertically shifted in a downward direction.

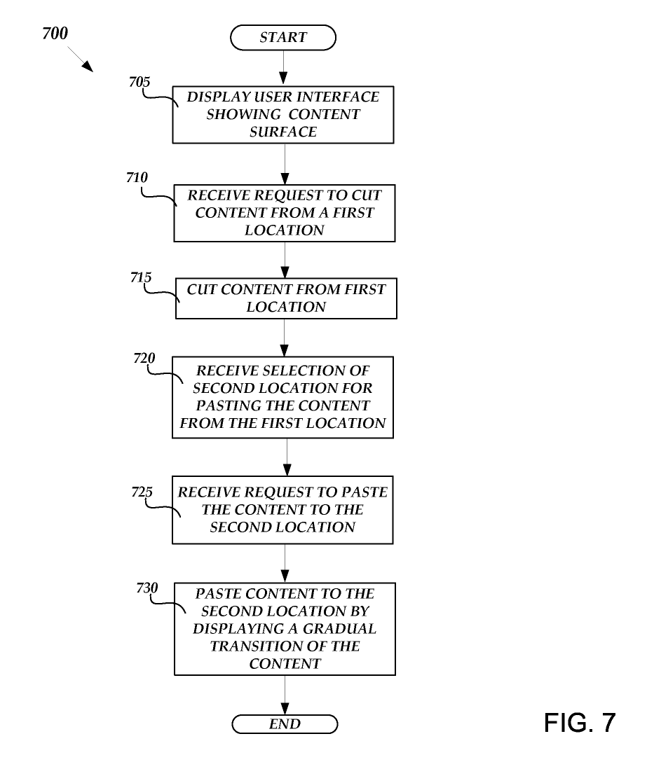

FIG. 7 is a flow diagram illustrating a routine 700 for animating the cut and paste of content in an electronic document, in accordance with an embodiment. When reading the discussion of the routine presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIGS. 7-9 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 700 begins at operation 705, where a computing device may be utilized to execute one or more productivity applications for displaying a user interface comprising a content surface for editing content. For example, the productivity applications may comprise a spreadsheet application operative to generate the user interface 100 of FIG. 1 in which a user may create and/or edit the content 115 on the content surface 105.

From operation 705, the routine 700 continues to operation 710, where the productivity applications executing on the computing device may receive a request to cut content from a first location. In accordance with an embodiment, the request to cut the content may be initiated within the user interface by using a keyboard shortcut command (e.g., CTRL+C), a selection of a Cut command from a toolbar menu in the user interface and/or a selection of a Cut icon (e.g., a scissors icon) from a toolbar displayed in the user interface. In accordance with an embodiment, the first location may be located on the content surface on which a user plans to paste the content. In accordance with another embodiment, the first location may be located outside of the content surface on which the user plans to paste the content (i.e., in another electronic document).

From operation 710, the routine 700 continues to operation 715, where the productivity applications executing on the computing device may cut the content from the first location on the content surface. In accordance with an embodiment, the user interface may display a confirmation that the content has been cut by surrounding the cut content with animated dashed lines (as shown in FIG. 1). In accordance with another embodiment, the cut content may simply be removed from the document.

From operation 715, the routine 700 continues to operation 720, where the productivity applications executing on the computing device may receive a selection of a second location for pasting the content cut from the first location on the content surface. For example, as discussed above with respect to FIG. 1, the paste location 120 (i.e., cell “B14”) may be selected on the content surface 105 for pasting the cut content.

From operation 720, the routine 700 continues to operation 725, where the productivity applications executing on the computing device may receive a request to paste the cut content to the second location. In accordance with an embodiment, the request to paste the content may be initiated within the user interface by using a keyboard shortcut command (e.g., CTRL+V), a selection of a Paste command from a toolbar displayed in the user interface and/or a selection of a Paste icon (e.g., a clipboard icon).

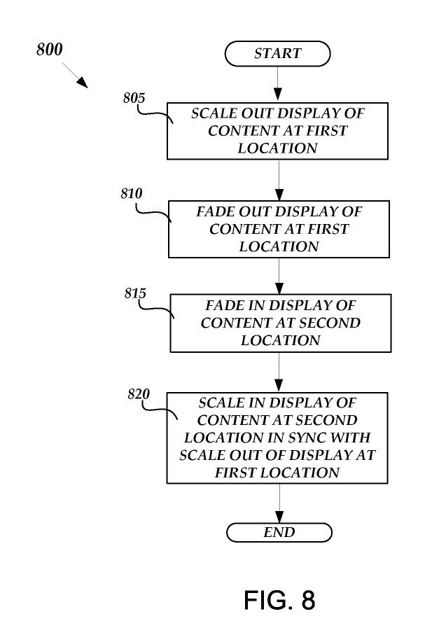

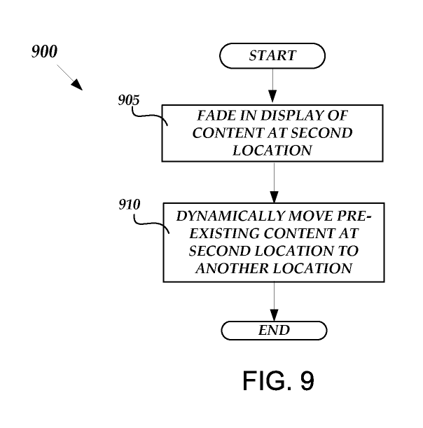

From operation 725, the routine 700 continues to optional operation 730, where the productivity applications executing on the computing device may paste the cut content to the second location by displaying a gradual transition of the content. In particular, the productivity applications may be configured to animate a paste operation such that a user may visually see the content transition or move from the first location to the second location in a user interface. Thus, it may be appreciated that in accordance with embodiments discussed herein, the user may be presented with a real-word physical analogy for cut-and-paste such that the user may perceive the movement of content as it travels between locations. Illustrative routines detailing the gradual transition of content during a paste operation will be described in greater detail below with respect to FIGS. 8-9. From operation 730, the routine 700 then ends.

FIG. 8 is a flow diagram illustrating a routine for animating the pasting of content in an electronic document, in accordance with an embodiment. The routine 800 begins at operation 805, where a computing device may be utilized to execute one or more productivity applications to “scale out” the display of content at the location from which the content has been cut (i.e., a first location). For example, as discussed above with respect to FIG. 1, after a Paste command has been received, the cut content 115 in the user interface 100 may gradually shrink. In particular, the productivity applications may be configured to gradually reduce the cut content 115 in size (e.g., to a smaller and narrower font) as compared to the size of the content 115 prior the paste operation being initiated.

From operation 805, the routine 800 continues to operation 810, where the productivity applications executing on the computing device may fade out the display of the content at the first location. For example, as discussed above with respect to FIG. 1 and in conjunction with the scaling out operation discussed at operation 805, the cut content 115 in the user interface 100 may gradually fade out from view on the content surface 105. It should be appreciated that the “scale out” and fade out operations described in operations 805 and 810 may be perceived by the user as occurring simultaneously or nearly simultaneously after a Paste command has been received by the productivity applications executing on the computing device. It should further be appreciated that in accordance with another embodiment, the “scale out” and fade out operations 805 and 810 may not be displayed to a user where content has been cut from outside of the content surface the user is currently viewing (e.g., the content was previously cut from another electronic document prior to the user initiating a Paste command to paste the content onto the content surface of the electronic document the user is currently viewing).

From operation 810, the routine 800 continues to operation 815, where the productivity applications executing on the computing device may fade in the display of content at the paste location (i.e., a second location) on a content surface. For example, as discussed above with respect to FIG. 1, the cut content 115 in the user interface 100 may gradually fade in to view at the paste location 120 on the content surface 105.

From operation 815, the routine 800 continues to operation 820, where the productivity applications executing on the computing device may “scale in” the display of content at the paste or second location at which the content is being pasted. For example, as discussed above with respect to FIG. 1, the expanding or “scaling in” of the content 115 may comprise displaying the content 115 in the user interface 100 as gradually increasing in size (e.g., increasing the size of text from a smaller and narrower font to a larger and wider font) until the size of the content 115 has returned to its original size (i.e., the size of the content prior to the Paste command being initiated). It should be appreciated that the fade in and “scale in” operations described in operations 815 and 820 may be perceived by the user as occurring simultaneously or nearly simultaneously. It should be further be appreciated that the “scale out” operation described in operation 805 and the “scale in” operation described in operation 820 may be synchronous operations. For example, with referring now to FIG. 1, the content 115 which has been cut at the first location may be displayed as gradually disappearing from view on the content surface 105 while, at the same time, the content 115 is displayed as gradually coming into view at the paste location 120. Thus, it may be appreciated that during the aforementioned gradual transition, the content 115 may be visible to a user (e.g., for a short time) at both the first and second locations during a Paste operation, in accordance with an embodiment. From operation 820, the routine 800 then ends.

FIG. 9 is a flow diagram illustrating a routine for animating the pasting of content in an electronic document, in accordance with an embodiment. The routine 900 begins at operation 905, where a computing device may be utilized to execute one or more productivity applications to fade in the display of content at a paste or second location on a content surface. For example, as discussed above with respect to FIG. 3, the cut content 315 may be displayed as gradually fading into view at the paste location 320 on the content surface 305.

From operation 905, the routine 900 continues to operation 910, where the productivity applications executing on the computing device may dynamically move any pre-existing content at the paste or second location to another location on a content surface in an electronic document. For example, as discussed above with respect to FIG. 5, as the content 515 is being pasted to the paste location 520, any pre-existing content 525 at the paste location 520 is dynamically moved away from the paste location 520. For example, as shown in FIG. 5, the pre-existing content 525 is in the process of being vertically shifted in a downward direction as the content 515 is being pasted to the paste location 520. It should be understood that, in accordance with an embodiment, if, while moving the pre-existing content to another location, additional pre-existing content is determined to be located at the another location, the additional pre-existing may also be dynamically moved to a new location on the content surface. For example, as discussed above with respect to FIG. 3, as the content as the content 315 is being pasted to the paste location 320, the pre-existing content 325 at the paste location 320 is dynamically shifted laterally to the right of the paste location 320 and as the pre-existing content 325 encroaches upon the additional pre-existing content 330, the pre-existing content 330 is then dynamically shifted laterally to a new location on the content surface 305. For example, FIG. 4 shows the final positions of the content 31, the pre-existing content 325 and the additional pre-existing content 330 after having been dynamically moved during a Paste operation. From operation 920, the routine 900 then ends.

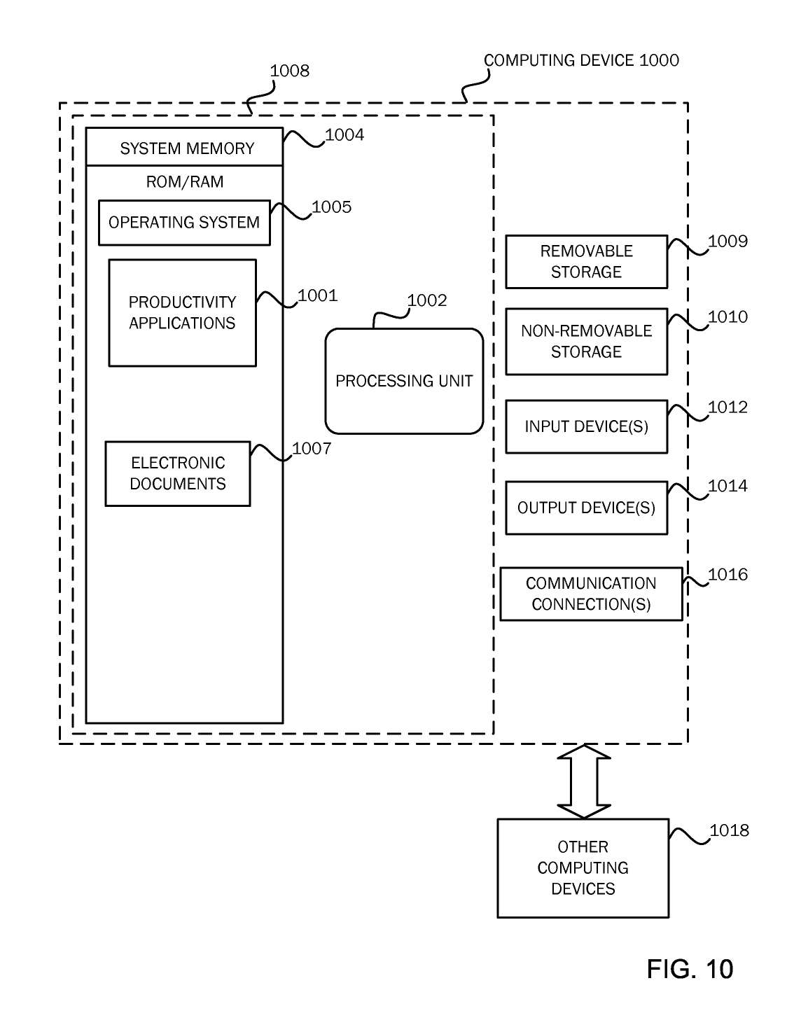

FIG. 10 is a block diagram illustrating example physical components of a computing device 1000 with which various embodiments may be practiced. The computing device components described below may be suitable for the computing device described above with respect to FIGS. 1-9. In a basic configuration, the computing device 1000 may include at least one processing unit 1002 and a system memory 1004. Depending on the configuration and type of computing device, system memory 1004 may comprise, but is not limited to, volatile (e.g. random access memory (RAM)), non-volatile (e.g. read-only memory (ROM)), flash memory, or any combination. System memory 1004 may include an operating system 1005, one or more productivity applications 1001 and electronic documents 1007. Operating system 1005, for example, may be suitable for controlling computing device 1000's operation and, in accordance with an embodiment, may comprise the WINDOWS operating systems from MICROSOFT CORPORATION of Redmond, Wash. The productivity applications 1001 may comprise the WORD word processing software, POWERPOINT presentation graphics software, EXCEL spreadsheet software, VISIO diagramming software, PROJECT project management software, PUBLISHER publishing software, OUTLOOK personal information management software and the ONENOTE note-taking software from MICROSOFT CORPORATION of Redmond Wash. It should be appreciated that the aforementioned productivity applications 1005 may comprise individual application programs or alternatively, may be incorporated into a suite of productivity applications such as the OFFICE application program suite from MICROSOFT CORPORATION. It should be understood, however, that other productivity application programs from other manufacturers may be utilized in accordance with the various embodiments described herein. In accordance with an embodiment, the electronic documents 1007 may comprise documents generated by or displayed in a user interface generated by the productivity applications 1001. For example, in accordance with various embodiments, the electronic documents 1007 may include, without limitation, word processing documents, presentation documents, spreadsheet documents, diagramming documents, project management documents, publishing documents, personal information management documents and note-taking documents. It should be understood that the embodiments described herein may also be practiced in conjunction with other operating systems and application programs and further, is not limited to any particular application or system.

The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010.

While executing on the processing unit 1002 of the computing device 1000, the productivity applications 1001 may perform routines for animating the cut and paste of content in an electronic document including, for example, one or more of the operations in routines 700, 800 and 900 described above. The aforementioned routines are examples, and the processing unit 1002 may perform other routines. Generally, consistent with various embodiments, program modules may be provided which include routines, programs, components, data structures, and other types of structures that may perform particular tasks or that may implement particular abstract data types. Moreover, various embodiments may be practiced with other computer system configurations, including hand-held devices, multiprocessor systems, microprocessor-based or programmable consumer electronics, minicomputers, mainframe computers, and the like. Various embodiments may also be practiced in distributed computing environments where tasks are performed by remote processing devices that are linked through a communications network. In a distributed computing environment, program modules may be located in both local and remote memory storage devices.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the productivity applications 1001 may operate via application-specific logic integrated with other components of the computing device/system 1000 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Various embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. The system memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 1000. Any such computer storage media may be part of the computing device 1000. The computing device 1000 may also have input device(s) 1012 such as a keyboard, a mouse, a pen, a sound input device, a touch input device, etc. Output device(s) 1014 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

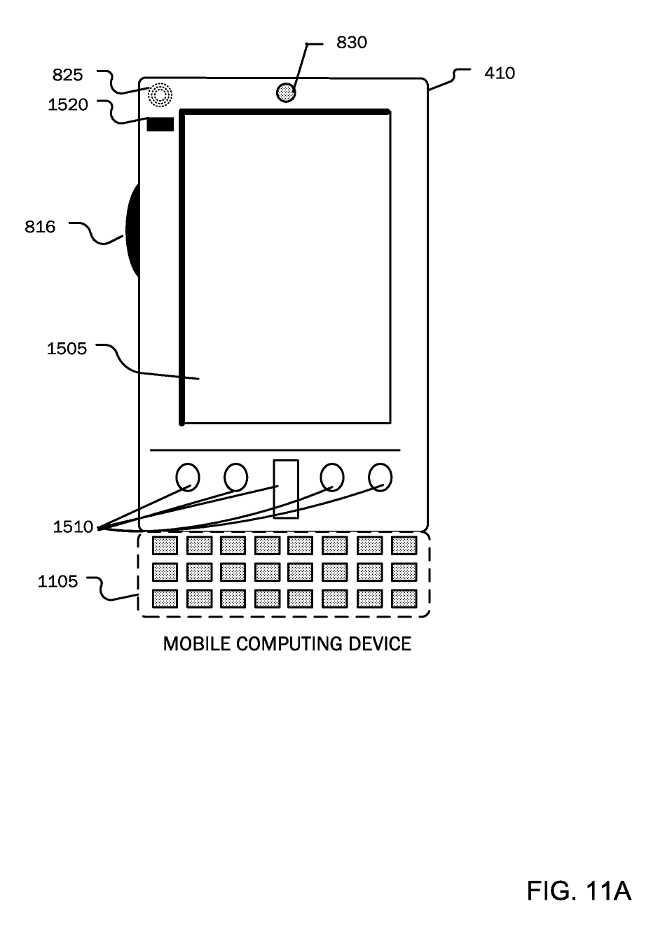

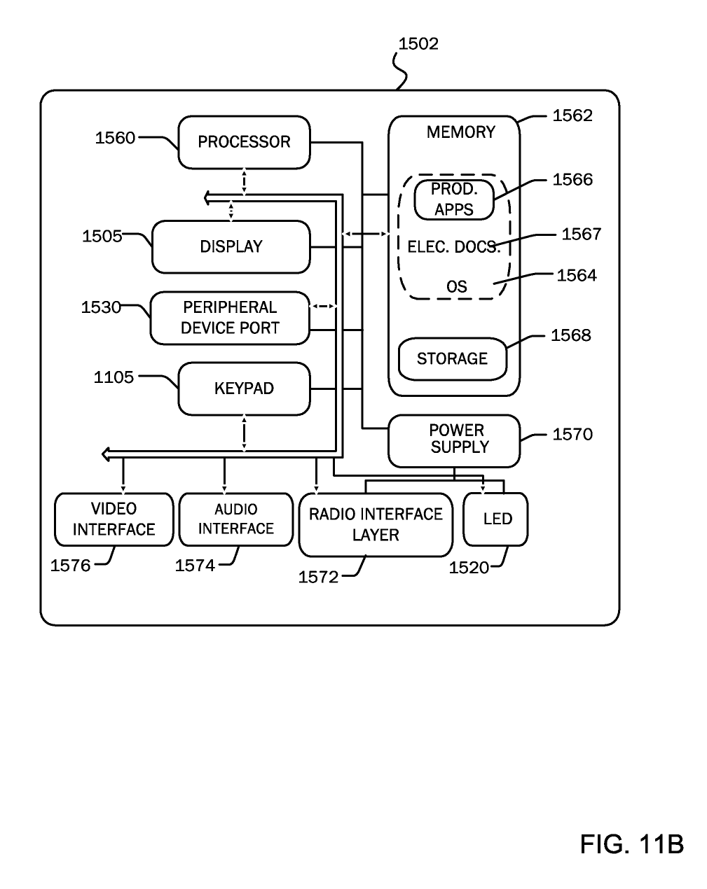

FIGS. 11A and 11B illustrate a suitable mobile computing environment, for example, a mobile telephone 410, a smartphone, a tablet personal computer, a laptop computer, and the like, with which various embodiments may be practiced. With reference to FIG. 15A, an example mobile computing device 410 for implementing the embodiments is illustrated. In a basic configuration, mobile computing device 410 is a handheld computer having both input elements and output elements. Input elements may include touch screen display 1505 and input buttons 1515 that allow the user to enter information into mobile computing device 410. Mobile computing device 410 may also incorporate an optional side input element 816 allowing further user input. Optional side input element 816 may be a rotary switch, a button, or any other type of manual input element. In alternative embodiments, mobile computing device 410 may incorporate more or less input elements. For example, display 1505 may not be a touch screen in some embodiments. In yet another alternative embodiment, the mobile computing device is a portable phone system, such as a cellular phone having display 1505 and input buttons 1515. Mobile computing device 410 may also include an optional keypad 1515. Optional keypad 1515 may be a physical keypad or a “soft” keypad generated on the touch screen display.

Mobile computing device 410 incorporates output elements, such as display 1505, which can display a graphical user interface (GUI). Other output elements include speaker 825 and LED light 1520. Additionally, mobile computing device 410 may incorporate a vibration module (not shown), which causes mobile computing device 410 to vibrate to notify the user of an event. In yet another embodiment, mobile computing device 410 may incorporate a headphone jack (not shown) for providing another means of providing output signals.

Although described herein in combination with mobile computing device 410, in alternative embodiments may be used in combination with any number of computer systems, such as in desktop environments, laptop or notebook computer systems, multiprocessor systems, micro-processor based or programmable consumer electronics, network PCs, mini computers, main frame computers and the like. Various embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate the various embodiments described herein.

FIG. 11B is a block diagram illustrating components of a mobile computing device used in one embodiment, such as the computing device shown in FIG. 11A. That is, mobile computing device 410 can incorporate a system 1502 to implement some embodiments. For example, system 1502 can be used in implementing a “smart phone” that can run one or more applications similar to those of a desktop or notebook computer such as, for example, one or more of the productivity applications discussed above with respect to FIG. 1 as well as browser, e-mail, scheduling, instant messaging, and media player applications. In some embodiments, the system 1502 is integrated as a computing device, such as an integrated personal digital assistant (PDA) and wireless phone.

One or more productivity applications 1566 may be loaded into memory 1562 and run on or in association with an operating system 1564. The productivity applications 1566 may be perform routines for animating the cut and paste of content in an electronic document including, for example, one or more of the operations in routines 700, 800 and 900 described above. The productivity applications 1566 may include, but are not limited to, word processing software, presentation graphics software, spreadsheet software, diagramming software, project management software, publishing software, personal information management software and note-taking software. The memory 1562 may also include one or more electronic documents 1567 which may be generated by one or more of the productivity applications 1566. The system 1502 also includes non-volatile storage 1568 within memory the 1562. Non-volatile storage 1568 may be used to store persistent information that should not be lost if system 1502 is powered down. The productivity applications 1566 may use and store information in the non-volatile storage 1568. A synchronization application (not shown) also resides on system 1502 and is programmed to interact with a corresponding synchronization application resident on a host computer to keep the information stored in the non-volatile storage 1568 synchronized with corresponding information stored at the host computer. As should be appreciated, other applications may also be loaded into the memory 1562 and run on the device 410.

The system 1502 has a power supply 1570, which may be implemented as one or more batteries. The power supply 1570 might further include an external power source, such as an AC adapter or a powered docking cradle that supplements or recharges the batteries.

The system 1502 may also include a radio 1572 that performs the function of transmitting and receiving radio frequency communications. The radio 1572 facilitates wireless connectivity between the system 1502 and the “outside world,” via a communications carrier or service provider. Transmissions to and from the radio 1572 are conducted under control of OS 1564. In other words, communications received by the radio 1572 may be disseminated to the productivity applications 1566 via OS 1564, and vice versa.

The radio 1572 allows the system 1502 to communicate with other computing devices, such as over a network. The radio 1572 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The embodiment of the system 1502 is shown with two types of notification output devices; an LED 1520 that can be used to provide visual notifications and an audio interface 1574 that can be used with speaker 825 to provide audio notifications. These devices may be directly coupled to the power supply 1570 so that when activated, they remain on for a duration dictated by the notification mechanism even though processor 1560 and other components might shut down for conserving battery power. The LED 1520 may be programmed to remain on indefinitely until the user takes action to indicate the powered-on status of the device. The audio interface 1574 is used to provide audible signals to and receive audible signals from the user. For example, in addition to being coupled to speaker 825, the audio interface 1574 may also be coupled to a microphone 820 to receive audible input, such as to facilitate a telephone conversation. In accordance with embodiments of the present invention, the microphone 820 may also serve as an audio sensor to facilitate control of notifications. The system 1502 may further include a video interface 1576 that enables an operation of on-board camera 830 to record still images, video stream, and the like.

A mobile computing device implementing the system 1502 may have additional features or functionality. For example, the device may also include additional data storage devices (removable and/or non-removable) such as, magnetic disks, optical disks, or tape. Such additional storage is illustrated in FIG. 11B by storage 1568. Computer storage media may include volatile and nonvolatile, removable and non-removable media implemented in any method or technology for storage of information, such as computer readable instructions, data structures, program modules, or other data.

Data/information generated or captured by the device 410 and stored via the system 1502 may be stored locally on the device 410, as described above, or the data may be stored on any number of storage media that may be accessed by the device via the radio 1572 or via a wired connection between the device 410 and a separate computing device 405 associated with the device 410, for example, a server computer in a distributed computing network such as the Internet. As should be appreciated such data/information may be accessed via the device 410 via the radio 1572 or via a distributed computing network. Similarly, such data/information may be readily transferred between computing devices for storage and use according to well-known data/information transfer and storage means, including electronic mail and collaborative data/information sharing systems.

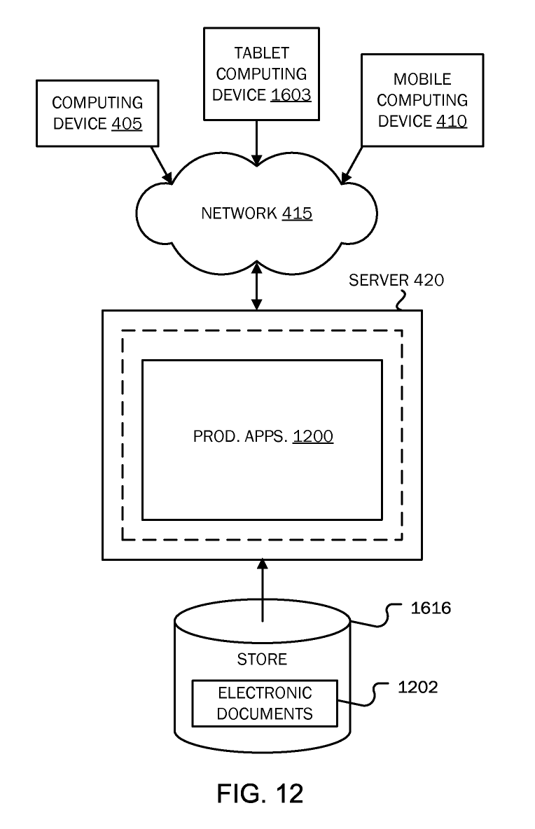

FIG. 12 is a simplified block diagram of a distributed computing system in which various embodiments may be practiced. The distributed computing system may include number of client devices such as a computing device 405, a table computing device 1603 and a mobile computing device 410. The client devices 405, 1603 and 410 may be in communication with a distributed computing network 415 (e.g., the Internet). A server 420 is in communication with the client devices 405, 1603 and 410 over the network 415. The server 420 may store one or more productivity applications 1200 which may be perform routines for animating the cut and paste of content in an electronic document including, for example, one or more of the operations in routines 700, 800 and 900 described above. The productivity applications 1200 may include, but are not limited to, word processing software, presentation graphics software, spreadsheet software, diagramming software, project management software, publishing software, personal information management software and note-taking software. The productivity applications 1200 on the server 420 may be utilized by the client devices 405, 1603 and 410 (over the network 415) to generate electronic documents 1202 and for storing same in a store 1616.

Various embodiments are described above with reference to block diagrams and/or operational illustrations of methods, systems, and computer program products according to embodiments of the invention. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

While certain embodiments have been described, other embodiments may exist. Furthermore, although various embodiments have been described as being associated with data stored in memory and other storage mediums, data can also be stored on or read from other types of computer-readable media, such as secondary storage devices (i.e., hard disks, floppy disks, or a CD-ROM), a carrier wave from the Internet, or other forms of RAM or ROM. Further, the disclosed routines' operations may be modified in any manner, including by reordering operations and/or inserting or operations, without departing from the invention.

It will be apparent to those skilled in the art that various modifications or variations may be made without departing from the scope or spirit of the invention. Other embodiments will be apparent to those skilled in the art from consideration of the specification and practice of the invention disclosed herein.

What is claimed is:

1. A computer-implemented method for animating cut and paste of content in an electronic document, comprising:
displaying, by a computer, a user interface comprising a content surface for editing the content;
receiving, by the computer, a request to cut the content from a first location;
cutting, by the computer, the content from the first location;
receiving, by the computer, a request to paste the content to a second location, the second location residing on the content surface; and
pasting, by the computer, the content to the second location by displaying a gradual transition of the content.

2. The method of claim 1, further comprising receiving a selection of the second location prior to receiving the request to paste the content to the second location.

3. The method of claim 1, wherein cutting, by the computer, the content from the first location comprises cutting the content from a first location on the content surface.

4. The method of claim 1, wherein cutting, by the computer, the content from the first location comprises cutting the content from a location outside of the content surface.

5. The method of claim 1, wherein displaying a gradual transition of the content comprises:
scaling out a display of the content at the first location;
fading out the display of the content at the first location;
fading in the display of the content at the second location; and
scaling in a display of the content at the second location, wherein scaling out the display of the content at the first location and scaling in the display of the content at the second location are synchronous operations.

6. The method of claim 1, wherein displaying a gradual transition of the content comprises:
fading in a display of the content at the second location; and
dynamically moving pre-existing content at the second location to another location on the content surface.

7. The method of claim 6, further comprising:
determining that there is at least one item of additional pre-existing content at the another location on the content surface; and
dynamically moving each item of additional pre-existing content from the another location to a new location on the content surface.

8. The method of claim 6, wherein dynamically moving pre-existing content at the second location to another location on the content surface comprises moving the pre-existing content laterally from the second location to the another location on the content surface.

9. The method of claim 6, wherein dynamically moving pre-existing content at the second location to another location on the content surface comprises moving the pre-existing content vertically from the second location to the another location on the content surface.

10. The method of claim 1, wherein displaying, by a computer, a user interface comprising a content surface for editing the content comprises displaying a user interface comprising a content surface for editing at least one of text, images and numbers.

11. The method of claim 1, wherein displaying, by a computer, a user interface comprising a content surface for editing the content comprises displaying a user interface comprising at least one of a spreadsheet document and a word processing document.

12. A computer system for animating cut and paste of content in an electronic document, comprising:
a memory for storing executable program code; and
a processor, functionally coupled to the memory, the processor being responsive to computer-executable instructions contained in the program code and operative to:
display a user interface comprising a content surface for editing the content;
receive a request to cut the content from a first location, the first location comprising at least one of a location on the content surface and a location outside of the content surface;
receive a selection of a second location, the second location residing on the content surface;
receive a request to paste the content to a second location; and
paste the content to the second location by displaying a gradual transition of the content.

13. The computer system of claim 12, wherein the processor, in displaying a gradual transition of the content is operative to:
scale out a display of the content at the first location;
fade out the display of the content at the first location;
fade in the display of the content at the second location; and
scale in a display of the content at the second location, wherein scaling out the display of the content at the first location and scaling in the display of the content at the second location are synchronous operations.

14. The computer system of claim 12, wherein the processor, in displaying a gradual transition of the content is operative to:
fade in a display of the content at the second location; and
dynamically move pre-existing content at the second location to another location on the content surface.

15. The computer system of claim 14, wherein the processor is further operative to:
determine that there is at least one item of additional pre-existing content at the another location on the content surface; and
dynamically move each item of additional pre-existing content from the another location to a new location on the content surface.

16. The computer system of claim 14, wherein the processor, in dynamically moving pre-existing content at the second location to another location on the content surface is further operative to move the pre-existing content laterally from the second location to the another location on the content surface.

17. The computer system of claim 14, wherein the processor, in dynamically moving pre-existing content at the second location to another location on the content surface is further operative to move the pre-existing content vertically from the second location to the another location on the content surface.

18. A computer-readable storage medium comprising computer executable instructions which, when executed by a computer, will cause the computer to perform a method for animating cut and paste of content in an electronic document, the method comprising:
displaying a user interface comprising a content surface for editing the content, the content surface comprising at least one of a spreadsheet document and a word processing document, the content comprising at least one of text, images and numbers.
receiving a request to cut the content from a first location, the first location comprising at least one of a location on the content surface and a location outside of the content surface;
receiving a selection of a second location, the second location residing on the content surface;
receiving a request to paste the content to a second location; and
pasting the content to the second location by displaying a gradual and synchronous transition of the content.

19. The computer-readable storage medium of claim 18, wherein displaying a gradual transition of the content comprises:
scaling out a display of the content at the first location;
fading out the display of the content at the first location;
fading in the display of the content at the second location; and
scaling in a display of the content at the second location, wherein scaling out the display of the content at the first location and scaling in the display of the content at the second location.

20. The computer-readable storage medium of claim 18, wherein displaying a gradual transition of the content comprises:
fading in a display of the content at the second location;
dynamically moving pre-existing content in at least one of a lateral direction and a vertical direction from the second location to another location on the content surface;
determining that there is at least one item of additional pre-existing content at the another location on the content surface; and
dynamically moving each item of additional pre-existing content in at least one of a lateral direction and a vertical direction from the another location to a new location on the content surface.
